(19) United States
(12) Patent Application Publication
(10) Pub. No.: US 2019/0315275 A1
(43) Pub. Date: Oct. 17, 2019

(54) DISPLAY DEVICE AND OPERATING METHOD THEREOF

(71) Applicant: LG ELECTRONICS INC., Seoul (KR)

(72) Inventors: Hangtae KIM, Seoul (KR); Kyungdong CHOI, Seoul (KR)

(73) Assignee: LG ELECTRONICS INC., Seoul (KR)

(21) Appl. No.: 16/461,252

(22) PCT Filed: Mar. 6, 2017
(86) PCT No.: PCT/KR2017/002392

§ 371 Date: May 15, 2019

(30) Foreign Application Priority Data
Nov. 21, 2016 (KR) 10-2016-0154731

(51) Int. Cl. B60R 1/00; H04N 7/18; H04N 13/204; G06F 3/01; B60K 35/00

(52) U.S. Cl. CPC B60R 1/001; H04N 7/181; H04N 13/204; G06F 3/013; B60K 35/00; B60K 2370/741; B60R 2300/303; B60R 2300/205; B60K 2370/52; B60K 2370/1529; B60R 2300/105

(57) ABSTRACT

A display device according to an embodiment of the present invention comprises: a front display unit; a side display unit including a left display unit and a right display unit; a communication unit for receiving external image data; a sensing unit for sensing a user; and a control unit for controlling an operation of the display device, wherein the control unit is configured to measure a position of the user's eyes inside a vehicle and a distance between the front display unit and the side display unit and the user's eyes by using the sensing unit, calculate the user's visible view and viewing angle through measured data, and process external image data corresponding to the calculated visible view to output the same to the side display unit.

### TECHNICAL FIELD

The present invention relates to a display device and a method of operating the same.

### BACKGROUND ART

A vehicle refers to an apparatus driven on a road or railroad by rolling wheels for the purpose of transporting persons or goods. For example, two-wheeled vehicles such as motorcycles, four-wheeled vehicles such as cars, and trains are vehicles.

Recently, with rapid development of display technology, various types of displays have been mounted in vehicles. Currently, thin film transistor-liquid crystal displays (TFT-LCDs) are mainly used as vehicle displays. As delivery of information related to driver safety and driving convenience has become important, a new type of display such as a head-up display (HUD) has also been commercialized.

However, a display apparatus such as a conventional head-up display (HUD) mounted in a vehicle has a small screen and thus can display only general information such as speed or gas mileage. Therefore, it is impossible to efficiently convey more information related to driver safety and a vehicle state.

Recently, technological development of a vehicle having an autonomous driving function for autonomously driving the vehicle from one position to another position has been accelerated.

### DISCLOSURE OF THE INVENTION

### Technical Problem

An object of the present invention is to provide a display device for a vehicle and a control method thereof for displaying different information for each driving mode.

Another object of the present invention is to secure driver's safe driving by fixing the line of sight of the driver in front of the vehicle while driving and detecting both the front and rear sides through a dual display device approaching the front.

Still further object of the present invention is to provide a cluster content display system of a layout required by a driver, capable of easily identifying the contents on the cluster just by the motion of the driver's eyes and capable of enlarging the contents and moving the position of the contents.

### Technical Solution

A display device according to one embodiment of the present invention may include: a front display unit; a side display unit comprising a left display unit and a right display unit; a communication unit configured to receive external image data; a sensing unit configured to sense a user; and a control unit configured to control an operation of the display device, wherein the control unit is configured to: measure a position of a user's eyes within a vehicle and a distance between the front display unit and the side display unit and the user's eyes by using the sensing unit; calculate a visible view and a viewing angle of the user through the measured data; and process the external image data corresponding to the calculated visible view and perform control to output the processed external image data on the side display unit.

In addition, in the display device according to one embodiment of the present invention, the front display unit may include a windshield of the vehicle.

In addition, in the display device according to one embodiment of the present invention, the side display unit may be mounted on an A-pillar position of the vehicle.

In addition, in the display device according to one embodiment of the present invention, the sensing unit may include a 3D camera, and the sensing unit is configured to sense the position of the user's eyes and sight direction information through the 3D camera.

In addition, in the display device according to one embodiment of the present invention, the 3D camera may be provided in a predetermined region of a steering wheel mounted on a front surface of a driver's seat of the vehicle.

In addition, in the display device according to one embodiment of the present invention, the external image data may be image data photographed through a general image camera and a time of flight (TOF) camera installed on the left and right sides of the vehicle.

In addition, in the display device according to one embodiment of the present invention, the general image camera may be configured to obtain 2D RGB images of left and right sides of the vehicle, and the control unit may be configured to combine distance information measured by the TOF camera with each pixel of the 2D RGB image.

In addition, in the display device according to one embodiment of the present invention, the display device may further include a user interface unit, and the control unit may be configured to control the side display unit to output navigation information upon receiving a navigation guidance request through the user interface unit.

A control method of a display device according to one embodiment of the present invention may include: measuring a position of a user's eyes within a vehicle and a distance between a front display unit and a side display unit and the user's eyes by using a sensing unit of the display device; calculating a visible view and a viewing angle of the user through the measured data; and processing external image data corresponding to the calculated visible view and outputting the processed external image data on the side display unit.

In addition, in the control method according to one embodiment of the present invention, the front display unit may include a windshield of the vehicle.

In addition, in the control method of the display device according to one embodiment of the present invention, the side display unit may be mounted on an A-pillar position of the vehicle.

In addition, in the control method of the display device according to one embodiment of the present invention, the sensing unit may include a 3D camera, and the sensing unit may be configured to sense the position of the user's eyes and sight direction information through the 3D camera.

In addition, in the control method of the display device according to one embodiment of the present invention, the 3D camera may be provided in a predetermined region of a steering wheel mounted on a front surface of a driver's seat of the vehicle.

In addition, in the control method of the display device according to one embodiment of the present invention, the external image data may be image data photographed through a general image camera and a time of flight (TOF) camera installed on the left and right sides of the vehicle.

In addition, in the control method of the display device according to one embodiment of the present invention, the general image camera may acquire 2D RGB images of left and right sides of the outside of the vehicle and may combine distance information measured by the TOF camera with each pixel of the 2D RGB images.

### Advantageous Effects

The present invention may have the following effects.

According to one embodiment of various embodiments of the present invention, information corresponding to the selected driving mode is displayed, thereby displaying appropriate information for each driving mode without receiving a separate input regarding the driving mode from the driver.

According to another embodiment of various embodiments of the present invention, driver's safe driving is secured by fixing the line of sight of the driver to the front during all driving (forward, backward, left and right turns, and the like) and detecting all the front and rear sides through a dual display device approaching the line of sight in front of a dashboard, and it is possible to arbitrarily adjust the angle of the side wide-angle camera mounted on the side mirror, thereby eliminating the blind spots at the time of driving and parking.

According to another embodiment of various embodiments of the present invention, the contents in the cluster can be easily identified just by the motion of the driver's eyes, and it is possible to expand the contents or move the position of the contents, thereby providing a cluster content display system of a layout required by the driver.

### BRIEF DESCRIPTION OF THE DRAWINGS

FIGS. 1A and 1B are schematic diagrams showing a vehicle including a display apparatus according to embodiments of the present invention.

FIG. 2 is a diagram showing the function of the vehicle shown in FIG. 1.

FIG. 3 is a diagram showing the function of a display apparatus according to a first embodiment of the present invention.

FIG. 4 is a diagram showing an example in which the display apparatus according to the first embodiment of the present invention controls a display.

FIG. 5 is a diagram showing another example in which the display apparatus according to the first embodiment of the present invention controls a display.

FIGS. 6A to 6C are diagrams showing another example in which the display apparatus according to the first embodiment of the present invention controls a display.

FIGS. 7A and 7B are diagrams showing another example in which the display apparatus according to the first embodiment of the present invention controls a display.

FIG. 8 is a diagram showing the function of a display apparatus according to a second embodiment of the present invention.

FIGS. 9A and 9B are diagrams showing an example in which the display apparatus according to the second embodiment of the present invention controls a display.

FIGS. 10A and 10B are diagrams showing another example in which the display apparatus according to the second embodiment of the present invention controls a display.

FIGS. 11A and 11B are diagrams showing another example in which the display apparatus according to the second embodiment of the present invention controls a display.

FIGS. 12A and 12B are diagrams showing another example in which the display apparatus according to the second embodiment of the present invention controls a display.

FIGS. 13A and 13B are diagrams showing an example in which the display apparatus according to the second embodiment of the present invention displays a blind spot image.

FIGS. 14A and 14B are diagrams showing another example in which the display apparatus according to the second embodiment of the present invention controls a display.

FIG. 15 is a configuration diagram of a driver sensing device according to an embodiment of the present invention.

FIG. 16 is a configuration diagram of a driver sensing device according to another embodiment of the present invention.

FIG. 17 is a block configuration diagram of a driver condition monitoring device according to an embodiment of the present invention.

FIG. 18 is a block configuration diagram illustrating a 3D image display device using a TOF principle.

FIGS. 19 to 22 are diagrams for explaining examples in which a display device according to still further embodiment of the present invention controls a display according to a driver's viewing angle.

### BEST MODE

Exemplary embodiments of the present invention will be described below in detail with reference to the accompanying drawings in which the same reference numbers are used throughout this specification to refer to the same or like parts and a repeated description thereof will be omitted.

The suffixes “module” and “unit” of elements herein are used for convenience of description and thus can be used interchangeably and do not have any distinguishable meanings or functions. In describing the present invention, a detailed description of known functions and configurations will be omitted when it may obscure the subject matter of the present invention. The accompanying drawings are used to aid in understanding the technical scope of the present invention and it should be understood that the scope of the present invention is not limited by the accompanying drawings. The idea of the present invention should be construed to extend to any alterations, equivalents and substitutions in addition to the accompanying drawings.

It will be understood that, although the terms first, second, etc. may be used herein to describe various elements of the present invention, these terms are only used to distinguish one element from another element and essential, order, or sequence of corresponding elements are not limited by these terms.

It will be understood that when one element is referred to as being “connected to” or “coupled to” another element, one element may be “connected to” or “coupled to”, another element via a further element although one element may be directly connected to or directly accessed to another element.

A singular representation may include a plural representation unless context clearly indicates otherwise.

It will be understood that the terms “comprise”, “include”, etc., when used in this specification, specify the presence of several components or several steps and part of the components or steps may not be included or additional components or steps may further be included.

Hereinafter, a vehicle including a display apparatus according to an embodiment of the present invention will first be described and then the display apparatus according to each embodiment of the present invention will be described.

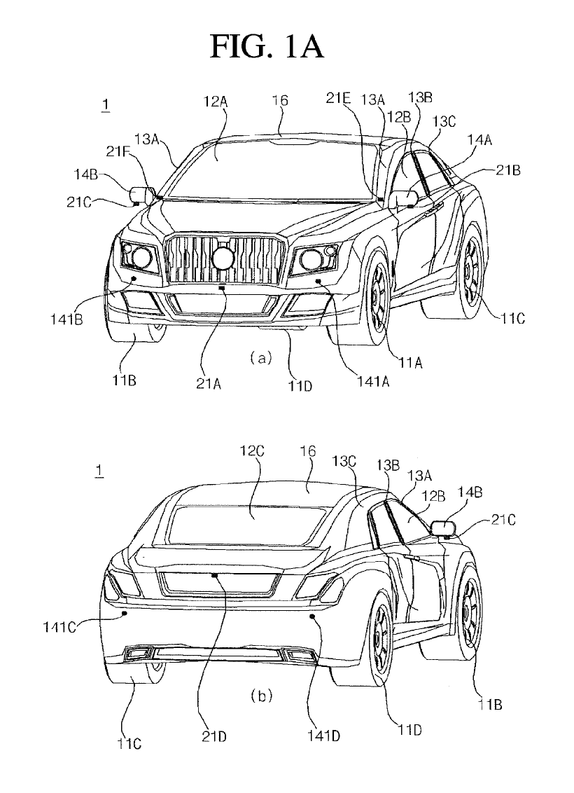

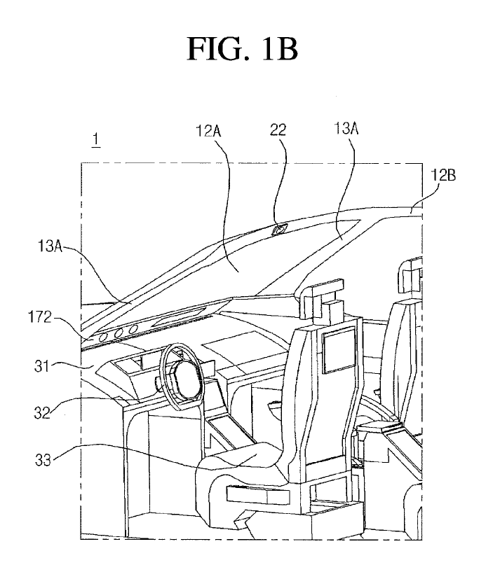

FIGS. 1A and 1B are schematic diagrams showing a vehicle 1 including a display apparatus 100 according to embodiments of the present invention. FIG. 1A shows the exterior of the vehicle 1 and FIG. 1B shows the interior of the vehicle 1. For convenience of description, a four-wheeled vehicle 1 will be focused upon.

Referring to FIG. 1A, the vehicle 1 may include a wheel 11, a window 12, a pillar 13, a side-view mirror 14, a roof 16, etc.

The wheel 11 includes front wheels 11A and 11B arranged on the right and left sides of the front side of the vehicle 1 and rear wheels 11C and 11D arranged on the right and left sides of the rear side of the vehicle 1 to support the load of the vehicle 1.

The window 12 may include a front window 12A, a side window 12B and a rear window 12C.

The pillar 13 connects a car body and a roof and increases the strength of the vehicle 1. More specifically, a front pillar 13A provided between the front window 12A and the side window 12B, a center pillar 13B provided between a front door and a rear door and a rear pillar 13C provided between the side window 12B and the rear window 12C may be included.

A pair of front pillars 13A, a pair of center pillars 13B and a pair of rear pillars 13C may be provided.

The side-view mirror 14 enables a driver to see areas behind and to the sides of the vehicle 1.

As shown, the side-view mirror 14 may include a first side-view mirror 14A mounted on the exterior of a driver seat of the vehicle 1 and a second side-view mirror 14B mounted on the exterior of a passenger seat of the vehicle 1.

In addition, the vehicle 1 may include at least one camera 20. More specifically, the vehicle 1 may include at least one camera 21 (hereinafter, referred to as an exterior camera) for capturing the periphery of the vehicle 1. The exterior camera 21 may generate front, rear, left and right images of the vehicle 1. For example, a first exterior camera 21A may generate a front image, a second exterior camera 21B may generate a left image, a third exterior camera 21C may generate a right image and a fourth exterior camera 21D may generate a rear image.

In addition, at least one of the exterior cameras 21 may generate a blind spot image. For example, a fifth exterior camera 21E may generate an image of a left blind spot obscured by the left front pillar 13A and a sixth exterior camera 21F may generate an image of a right blind spot obscured by the right front pillar 13A.

In addition, the vehicle 1 may include at least one obstacle sensor 141. Although four obstacle sensors 141A to 141D are shown as being mounted on the exterior of the vehicle, the present invention is not limited thereto. That is, more or fewer obstacle sensors 141 may be provided at other positions of the vehicle 1.

Referring to FIG. 1B, a dashboard 31, a steering wheel 32, a seat 33, etc. are provided in the interior of the vehicle 1. In addition, various display apparatuses including an assistant display 172 may be provided in the interior of the vehicle 1.

In addition, at least one camera 22 (hereinafter, referred to as an interior camera) for capturing the interior of the vehicle 1 to generate an interior image may be mounted in the interior of the vehicle 1. Such an interior camera 22 may be provided on one side of the interior of the vehicle 1 to capture an area in which a driver is located.

As described above, the vehicle 1 including the display apparatus 100 according to the embodiments of the present invention is not limited to the four-wheeled vehicle shown in FIG. 1.

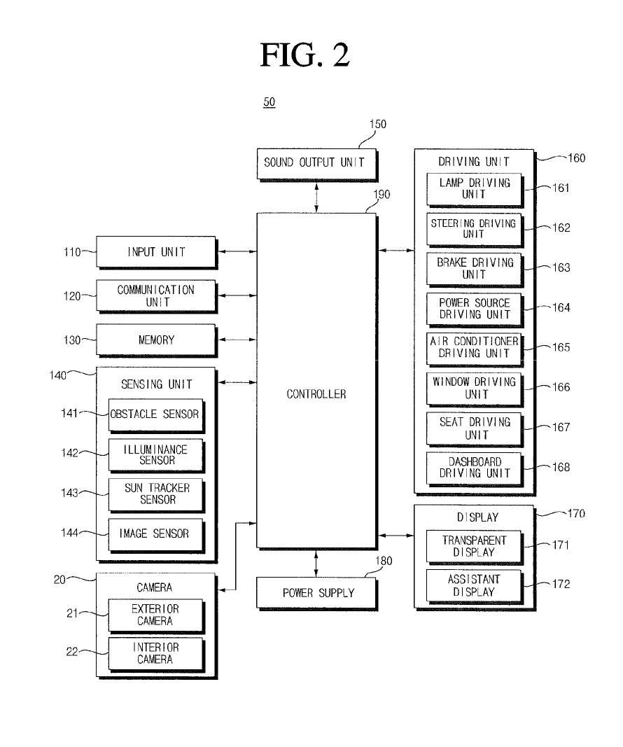

FIG. 2 is a diagram showing the function of a control device 50 provided in the vehicle 1 shown in FIG. 1.

Referring to FIG. 2, the control device 50 of the vehicle 1 may include a camera 20, an input unit 110, a communication unit 120, a memory 130, a sensing unit 140, an audio output unit 150, a driving unit 160, a display 170, a power supply 180 and a controller 190.

The camera 20 may include an exterior camera 21 and an interior camera 22.

The input unit 110 receives a variety of input from a driver. The input unit 110 may include at least one of a physical button, a joystick, a microphone, a touch panel, etc. For example, the driver may turn the vehicle 1 on/off, adjust volume, indoor temperature, radio channel, etc. or input a destination, a driving mode, etc. via the input unit 110.

The communication unit 120 may exchange a variety of data with an external apparatus by wire or wirelessly. For example, the communication unit 120 may establish a wireless communication link with a mobile terminal of the driver or a server to exchange a variety of data. A wireless data communication method may include, but is not limited thereto, various data communication methods such as Bluetooth, Wi-Fi Direct, Wi-Fi, APiX, etc.

In addition, the communication unit 120 may receive a variety of information such as weather information, position information, traffic information, route information, broadcast information, etc. from an external apparatus. For example, the communication unit 120 may receive transport protocol experts group (TPEG) information.

The communication unit 120 may perform pairing with the mobile terminal of the driver automatically or according to the request of the mobile terminal.

The memory 130 may store various application programs for data processing or control of the controller 190 and a variety of data for operation of an electronic control device, such as settings information set by the driver. The memory 130 may pre-store information to be displayed on the display 170 according to internal environment information or external environment information of the vehicle 1.

The sensing unit 140 senses a variety of information or signals related to an internal or external environment. The sensing unit 140 may include an image sensor for analyzing an image generated by the exterior camera 21 or the interior camera 22, a touch sensor for sensing touch of the driver and an obstacle sensor (141, see FIG. 1A) for sensing an obstacle located near the vehicle 1.

The sensing unit 140 may include a heading sensor, a yaw sensor, a gyroscope sensor, a position sensor, a speed sensor, a body tilting sensor, a battery sensor, a fuel sensor, a tire pressure sensor, a temperature sensor, a humidity sensor, etc. The sensing unit 140 may acquire the travel direction, speed, acceleration, body tilting, residual battery, fuel information, tire pressure, engine temperature, indoor temperature, indoor humidity, etc. of the vehicle 1.

The audio output unit 150 may convert a control signal received from the controller 190 into an audio signal and output the audio signal. The audio output unit 150 may include at least one speaker. For example, if a safety belt is not fastened in a state of starting a vehicle, the audio output unit 150 may output predetermined beat sound.

The driving unit 160 may include a lamp driving unit 161, a steering driving unit 162, a brake driving unit 163, a power source driving unit 164, an air conditioner driving unit 165, a window driving unit 166, a seat driving unit 167, a dashboard driving unit 168, etc.

The lamp driving unit 161 may turn various lamps provided in the vehicle 1 on/off. In addition, the lamp driving unit 161 may control the amount of light emitted from the lamp, an on/off period, the direction of light, etc.

The steering driving unit 162 may perform electronic control with respect to a steering device (e.g., a steering wheel 32) of the vehicle 1. Thus, it is possible to change the travel direction of the vehicle 1. Alternatively, the steering driving unit 162 may change the position or posture of the steering device (e.g., the steering wheel 32) of the vehicle 1. For example, the driver may adjust the height of the steering wheel 32 according to the body size thereof.

The brake driving unit 163 may perform electronic control with respect to the brake device of the vehicle 1. For example, operation of the brake provided in the wheel may be controlled to reduce the speed of the vehicle 1.

The power source driving unit 164 may perform electronic control with respect to the power source of the vehicle 1. For example, when the vehicle 1 uses an engine as a power source, the power source driving unit 164 may control torque of the engine, etc. As another example, when the vehicle 1 uses an electric motor as a power source, the power source driving unit 164 may control the rotation speed, torque, etc. of the motor.

The air conditioner driving unit 165 may perform electronic control with respect to the air conditioner of the vehicle 1. For example, when the indoor temperature of the vehicle 1 is high, the air conditioner driving unit 165 may operate the air conditioner to pass cold air into the interior of the vehicle.

The window driving unit 166 may individually open or close the windows of the vehicle 1.

The seat driving unit 167 adjusts the position or posture of the seat 33 provided in the vehicle 1 electrically, not manually. More specifically, the seat driving unit 167 may move the seat 33 in all directions using an electrical pump or an electrical motor or adjust the angle of the back of the seat. The seat 33 which is electrically adjusted by the seat driving unit 167 may be referred to as a power seat.

The dashboard driving unit 168 adjusts the position or height of the dashboard 31 provided in the interior of the vehicle 1. The dashboard driving unit 168 may change the position or height of the dashboard 31 using the electrical pump or the electrical motor, similarly to the seat driving unit 167.

The display 170 displays a variety of information related to the vehicle 1. The display 170 includes a transparent display 171. In addition, the display 170 may further include an assistant display 172. Here, the transparent display 171 may mean a display having a predetermined transmittance or more to enable the driver to perceive an object located behind the transparent display 171. In addition, the assistant display 172 may mean a display having less than a predetermined transmittance, unlike the transparent display 171.

At least one assistant display 172 or transparent display 171 may be provided. Several assistant displays 172 or transparent displays 171 may be provided at various positions of the vehicle 1. For example, the transparent display 171 may be mounted on at least one of the windows 12 shown in FIG. 1A. In addition, the assistant display 172 may be mounted between the front window 12A and the dashboard 31 shown in FIG. 1B.

The display 170 may display a variety of information or change a display state while operating under control of the controller 190. For example, the display 170 may change the type, form, amount, color, position, size, etc. of the information displayed on the display 170 or change the brightness, transmittance, color, etc. of the display 170 according to different control signals provided by the controller 190.

The power supply 180 may supply power necessary for operation of the components under control of the controller 190.

The controller 190 may control the overall operation of each unit included in the control device. For example, the controller 190 may change the attributes of the information displayed on the display 170 based on a signal received from the input unit 110 or the sensing unit 140.

The vehicle 1 may have a manual driving function for enabling the driver to directly drive the vehicle and an autonomous driving function. Here, the autonomous driving function means a function for detecting external information upon driving, recognizing a peripheral environment using a function for processing the detected external information, autonomously determining a driving route and independently driving the vehicle. That is, the controller 190 may automatically drive the vehicle 1 along a specific route using the autonomous driving function without operation of the driver. The autonomous driving function may be different from a driving assistance function in that the vehicle is driven without operation of the driver. That is, the driving assistance function can partially control the speed or motion of the vehicle but is different from the autonomous driving function in that operation of the driver is required to drive the vehicle along a predetermined route.

Some components of the control device 50 described with reference to FIG. 2 may be used in the display apparatus 100 according to the embodiments of the present invention. That is, the display apparatus 100 may include only some components of the control device 50 of the vehicle 1.

The display apparatus 100 according to the embodiments of the present invention can increase safety during driving and driver convenience by controlling the display 170 according to the internal environment information, external environment information or driving mode of the vehicle 1, which will be described in greater detail below.

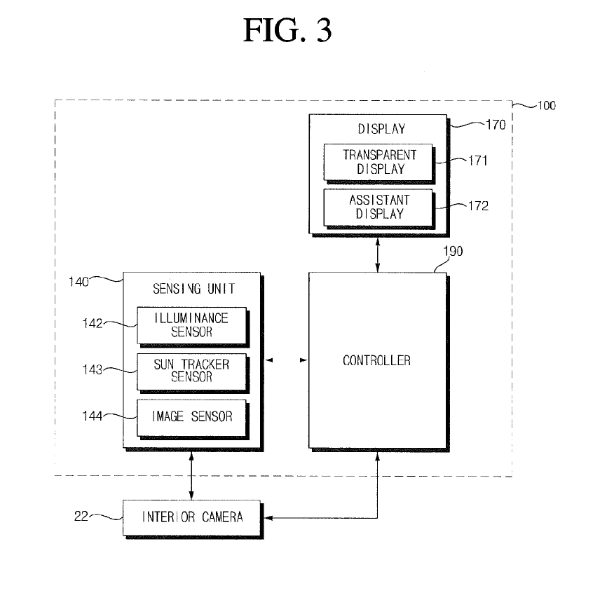

FIG. 3 is a diagram showing the function of a display apparatus 100 according to a first embodiment of the present invention. Referring to FIG. 3, the display apparatus 100 according to the first embodiment of the present invention includes a display 170, a sensing unit 140 and a controller 190. At this time, the display 170 includes at least one transparent display 171.

In addition, the display 170 may include at least one assistant display 172.

First, the transparent display 171 has a predetermined transmittance or more and may change a display state or display a variety of information based on data (e.g., a control signal) received from the controller 190.

The sensing unit 140 acquires internal environment information of the vehicle. The sensing unit 140 may include at least one sensor for sensing the internal environment of the vehicle 1.

The controller 190 controls operation of the transparent display 171 and the sensing unit 140. For example, the controller 190 activates at least some of the sensors included in the sensing unit 140 to receive information sensed by the activated sensors. In addition, the controller 190 may generate information corresponding to the internal environment information received from the sensing unit 140 and control display of the generated information on the transparent display 171.

More specifically, the transparent display 171 is applicable to the various windows 12 shown in FIG. 1A. For example, the transparent display 171 may overlap the front window 12A. Alternatively, instead of the front window 12A, the transparent display 171 may be mounted in the vehicle 1. Alternatively, the transparent display 171 may be mounted in the vehicle 1 to overlap the side window 12B or the rear window 12C or instead of the side window 12B or the rear window 12C.

Here, the display state of the transparent display 171 means brightness, transmittance, color, etc. The information displayed on the transparent display 171 may be represented in various forms such as a moving image, a still image, characters, numerals, symbols, etc.

For example, on the transparent display 171, numerical information indicating the speed of the vehicle 1 and symbol information indicating a route to be traveled may be displayed. However, the present invention is not limited to information related to driving of the vehicle 1 and a variety of content such as movies, the Internet, a music playback screen, pictures, etc. may be displayed on the transparent display 171.

The transparent display 171 may be mounted in or attached to the window 12 of the vehicle 1 shown in FIG. 1A or may be mounted in the vehicle 1 instead of the window of the vehicle 1. In particular, the front window 12A of the vehicle 1 may be replaced with the transparent display 171.

In addition, a touch sensor (not shown) may be provided to at least one of both sides of the transparent display 171. The transparent display 171 may detect direct or approaching touch of the driver and provide information of the position, area, strength, direction, speed, etc. of the detected touch to the controller 190. The controller 190 may change the display state of the transparent display 171, information displayed on the transparent display 171 or a control signal related to control of the vehicle 1 based on information related to touch received from the touch sensor. For example, the controller 190 may recognize a gesture intended by the driver based on the trajectory of the touch detected by the transparent display 171 and control (e.g., increase brightness of) the display 170 according to the recognized gesture.

In addition, the transparent display 171 may be implemented via various technologies. Technology for displaying a variety of information on the transparent display 171 may be largely divided into projection type technology and direct view technology.

For example, when the transparent display 171 is implemented by projection type technology, a projection device (not shown) provided in the interior of the vehicle 1 generates a virtual image such that the driver views the virtual image projected onto the transparent display 171.

As another example, when the transparent display 171 is implemented by direct view technology, the transparent display 171 directly displays predetermined information without a projection device.

Such direct view technology may be implemented via an electroluminescent display (ELD), an electrochromic display, an electrowetting display, a liquid crystal display, an organic light emitting diode (OLED), etc., for example. Hereinafter, for convenience of description, assume that the transparent display 171 is implemented by direct view technology.

As described above, the sensing unit 140 may sense the interior state of the vehicle 1, analyze data related to the interior state and acquire internal environment information.

Alternatively, the sensing unit 140 may sense the interior state of the vehicle 1 and provide data related to the interior state to the controller 190. The controller 190 may analyze the data received from the sensing unit 140 and acquire internal environment information.

The internal environment information of the vehicle 1 means information about the interior state of the vehicle 1. The controller 190 may acquire the internal environment information not only via the data received from the sensing unit 140 but also via the other various methods.

More specifically, the internal environment information may include driver information and information about the vehicle 1.

The driver information may include the gaze, facial expression, face direction, gesture, etc. of the driver located in the vehicle 1. For example, the sensing unit 140 may include an image sensor 144 and the image sensor 144 may analyze an interior image received from the interior camera 22 and detect the face, eyes, gestures, etc. of the driver appearing on the interior image.

In addition, the sensing unit 140 may track change in face direction, facial expression, gaze or gesture of the driver.

For example, the image sensor 144 may extract the color value of each pixel included in the interior image, compare a set of the extracted color values with an eye image pre-stored in the memory 130, and detect a part having an index of similarity of a predetermined value or more as the eyes of the driver. If each pixel is expressed by 8 bits, each pixel may have any one of 256 color values.

In addition, the controller 190 may change the position or size of at least one piece of information displayed on the transparent display 171 according to the point of gaze of the driver detected by the sensing unit 140.

For example, when the point of gaze of the driver is changed from the front side to the right side, the controller 190 may move some of the information displayed on the left side of the transparent display 171 to the right side and gradually enlarge the information. In contrast, when the point of gaze of the driver is changed from the right side to the front side, the controller 190 may move some of the information displayed on the right side of the transparent display 171 to the left side and gradually reduce the information. The changed size of the displayed information may correspond to a movement distance of the point of gaze of the driver on the transparent display 171.

As another example, the controller 190 may compare the gesture detected by the sensing unit 140 with gesture information pre-stored or defined in the memory 130 and display information corresponding to a first gesture on the transparent display 171 when the detected gesture corresponds to the first gesture in the result of comparison. When the detected gesture corresponds to a second gesture in the result of comparison, the controller 190 may change the brightness of the entire area or some area of the transparent display 171 to a predetermined value or less. Alternatively, when the detected gesture corresponds to a third gesture, at least some information displayed on the transparent display 171 may disappear.

The information about the vehicle 1 may include information about interior illuminance of the vehicle 1 or the angle of sunlight introduced into the interior of the vehicle 1. More specifically, the sensing unit 140 may sense the interior illuminance of the vehicle 1 using the illuminance sensor 142. In addition, the sensing unit 140 may sense the position of the sun using a sun tracker sensor 143. The sensing unit 140 may sense the direction of sunlight introduced into the interior of the vehicle 1 using the position of the sun.

The controller 190 compares the interior illuminance of the vehicle 1 sensed by the sensing unit 140 with a pre-stored reference illuminance value. When the interior illuminance of the vehicle 1 is greater than or equal to the pre-stored reference illuminance value as the result of comparison, a graphic object having a predetermined transmittance value or less may be displayed on the transparent display 171. Here, the reference illuminance value is an illuminance value when the driver is blinded by sunlight and may be decided by experimentation. The reference illuminance value may not be fixed and may be changed according to driver input.

A graphic object having a predetermined transmittance value or less may block light (e.g., direct sunlight) directed from the exterior of the vehicle 1 to the interior of the vehicle 1 and may function as a sun visor. Since an element such as a conventional sun visor may be replaced by the transparent display 171, it is possible to increase an interior space of the vehicle 1.

The controller 190 may adjust the position of the graphic object having the predetermined transmittance value or less, which is displayed on the transparent display 171, based on the direction of the sunlight sensed by the sensing unit 140. More specifically, for example, when the sunlight sensed by the sensing unit 140 is directed to the driver eyes appearing on the interior image, the controller 190 may control display of the graphic object having the predetermined transmittance value or less in an area, in which an extension connecting the position of the sun and the point of gaze of the driver intersect, in the entire area of the transparent display 171. Therefore, the display position of the graphic object having the predetermined transmittance value or less may be automatically changed on the transparent display 171 according to the direction of the sunlight, thereby increasing driver convenience and concentration.

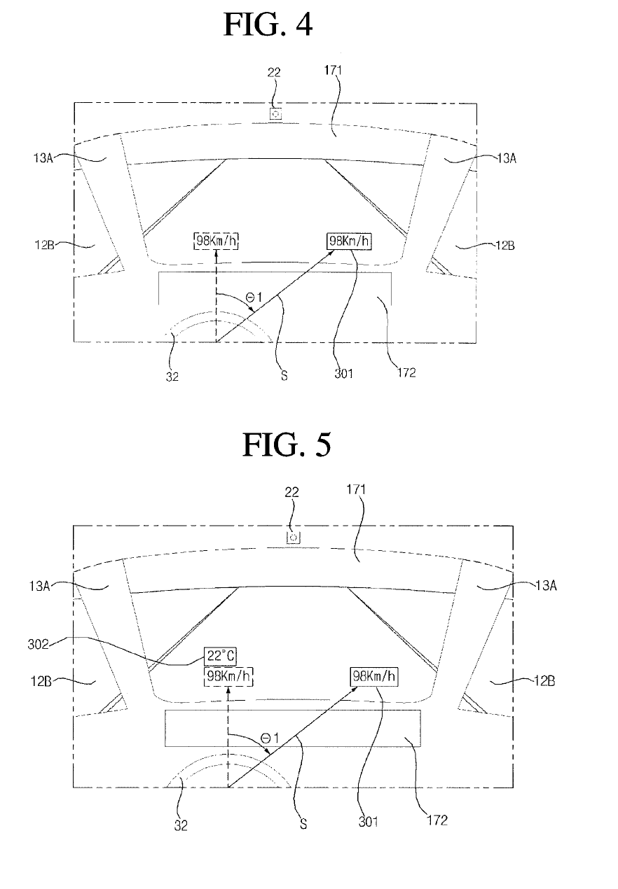

Hereinafter, the first embodiment of controlling the display 170 according to the internal environment information will be described in greater detail with reference to FIGS. 4 to 7.

FIG. 4 is a diagram showing an example in which the display apparatus 100 according to the first embodiment of the present invention controls the display 170. For convenience of description, FIG. 4 shows the case in which the front window 12A is implemented as the transparent display 171.

Referring to FIG. 4, the controller 190 may control operation of the transparent display 171 based on the gaze information of the driver among a variety of internal environment information. The controller 190 may change the position of information 301 displayed in a predetermined area including an intersection between the gaze S of the driver and the transparent display 171.

The interior camera 22 may generate the interior image including the driver and the sensing unit 140 may detect the driver eyes from the interior image and acquire gaze information. In order to generate the interior image including the driver eyes, the interior camera 22 may be provided on the front side of the driver to face the driver as shown.

The controller 190 changes the position of the information 301 indicating the speed of the vehicle 1 based on the gaze information of the driver.

When the gaze S of the driver is directed forward, the controller 190 may display the information 301 indicating the speed of the vehicle 1 in the front area of the driver seat of the entire area of the transparent display 171.

When the gaze S of the driver moves from the front side to the right side by a first angle θ1, the controller 190 may move the information 301 indicating the speed of the vehicle 1 to an area, to which the gaze S of the driver is directed, of the entire area of the transparent display 171. That is, the information 301 may be moved from the left lower end to the right lower end along with the gaze S of the driver.

Although the information 301 indicating the speed of the vehicle 1 is focused upon in FIG. 4, the present invention is not limited thereto. That is, the display position of not only the speed of the vehicle 1 but also a variety of information related to the vehicle 1 on the transparent display 171 may be changed according to the point of gaze of the driver.

The controller may display may display information other than the information displayed on the transparent display 171 on the assistant display 172. For example, information about an electronic map, a music file list, etc. may be displayed on the assistant display 172. The controller 190 may display selected information on any one of the transparent display 171 and the assistant display 172 according to driver input.

FIG. 5 is a diagram showing another example in which the display apparatus 100 according to the first embodiment of the present invention controls the display 170. For convenience of description, FIG. 5 shows the case in which the front window 12A is implemented as the transparent display 171.

The controller 190 may not change the display position of specific information even when the point of gaze of the driver is changed. More specifically, a variety of information may be classified into a first group in which the display position of information is changed according to the point of gaze of the driver and a second group in which the display position of information is not related to the point of gaze of the driver.

The information belonging to the first group may be directly related to driving of the vehicle 1. For example, information indicating the speed, route, speed limit, etc. of the vehicle 1 may belong to the first group.

The information belonging to the second group may not be related to driving of the vehicle 1. For example, information indicating played music, broadcast channel, radio volume, indoor temperature, etc. may belong to the second group.

Referring to FIG. 5, one piece of information 302 belonging to the first group and one piece of information 303 belonging to the second group are displayed on the transparent display 171. At this time, assume that the information 301 belonging to the first group indicates the speed of the vehicle 1 and the information 302 belonging to the second group indicates the indoor temperature.

As the point of gaze of the driver moves from the front side to the right side by a first angle θ1, the controller 190 may move the information 301 belonging to the first group to the right side of the transparent display 171 according to the change in gaze of the driver. In contrast, the controller 190 may control the display position of the information 302 belonging to the second group to be unchanged according to change in gaze of the driver.

That is, the display position of the information 302 belonging to the second group may not be related to the point of gaze of the driver.

The type or amount of the information belonging to the first group or the second group may be changed according to driver input.

Referring to FIG. 5, information unrelated to driving of the vehicle 1 (that is, information which does not influence the possibility for accidents) may be controlled to be unchanged according to change in gaze of the driver, thereby reducing driver confusion.

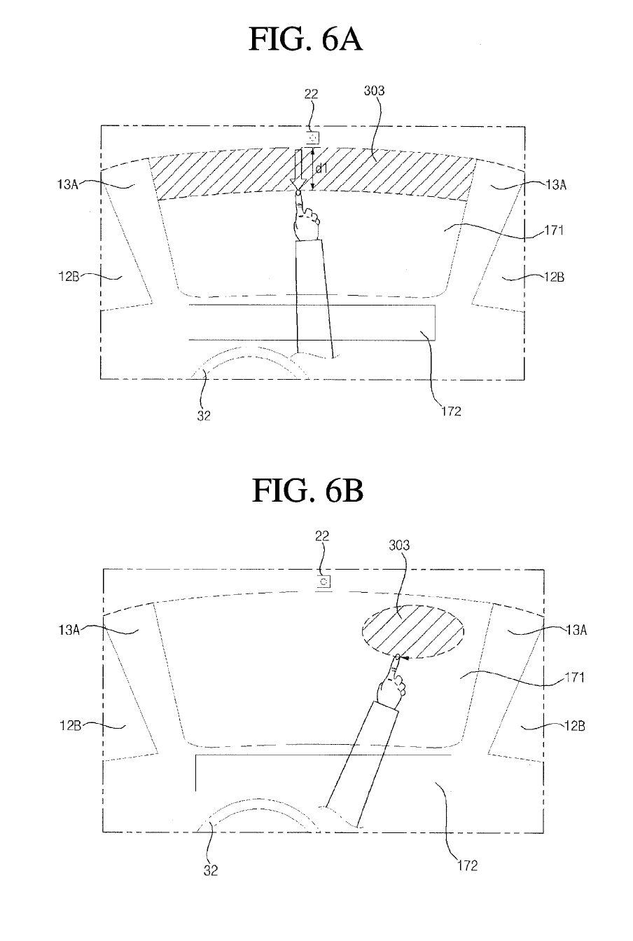

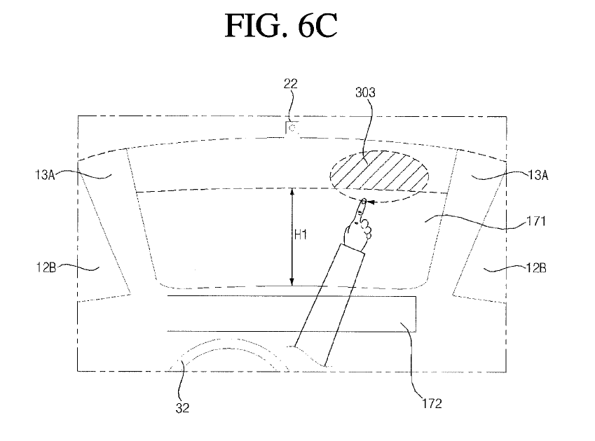

FIGS. 6A to 6C are diagrams showing another example in which the display apparatus 100 according to the first embodiment of the present invention controls the display 170. For convenience of description, FIGS. 6A to 6C show the case in which the front window 12A is implemented as the transparent display 171.

The interior camera 22 may generate an interior image including the driver and the sensing unit 140 may detect a driver gesture from the interior image and acquire gesture information. For example, the sensing unit 140 may detect a gesture corresponding to a trajectory drawn by the finger of the driver facing the transparent display 171 from the interior image. When a pattern corresponding to the detected gesture is present in a variety of pattern information pre-stored in the memory 130, the controller 190 may generate information corresponding to the pattern.

In addition, the controller 190 may display new information on the transparent display 171 or remove displayed specific information according to the direction, movement distance or speed of the detected gesture. Alternatively, the controller 190 may consecutively change the transmittance, brightness, etc. of the transparent display 171 according to the direction, movement distance or speed of the detected gesture.

FIGS. 6A to 6C show the state in which the controller 190 displays information 303 having a predetermined transmittance value or less on the transparent display 171 according to driver gestures. Such information 303 may be used to execute a sun protection function. That is, the information 303 having a predetermined transmittance value or less may be used to execute the function of a sun visor. The controller 190 may determine the display position of the information 303 having a predetermined transmittance value or less in the entire area of the transparent display 171 according to the position of the gesture. For example, the information 303 having a predetermined transmittance value or less may be displayed in an area corresponding to the position where the gesture is finished or between the start and end positions of the gesture in the entire area of the transparent display 171.

First, referring to FIG. 6A, the controller 190 may detect the trajectory of the finger of the driver moved from top to bottom by a predetermined distance dl as a gesture and display the information 303 having a length corresponding to the movement distance dl of the detected gesture. At this time, the information 303 may have the same width as the transparent display 171.

Referring to FIG. 6B, the controller 190 may detect the trajectory of the finger of the driver, which indicates a closed curve, as a gesture and display the information 303 having a size corresponding to the closed curve on the transparent display 171. The driver can simply display the information 303 using the gesture in the area having a position and size capable of blocking sunlight in the entire area of the transparent display 171.

Referring to FIG. 6C, the controller 190 may control the information 303 having the predetermined transmittance value or less to be not displayed at a position less than a specific height H1 of the transparent display 171. That is, the controller 190 may display the information 303 having the predetermined transmittance value or less only at the position greater than the specific height H1 of the transparent display 171 in the entire area of the transparent display 171. When some of the closed curve corresponding to the gesture is located at the position less than the specific height H1 of the transparent display 171, the controller 190 may display only the information 303 corresponding to the part of the closed curve located at the specific height H1 or more on the transparent display 171. Therefore, it is possible to prevent the information 303 from being displayed in an extremely low area of the transparent display to obstruct the field of vision of the driver due to a driver mistake.

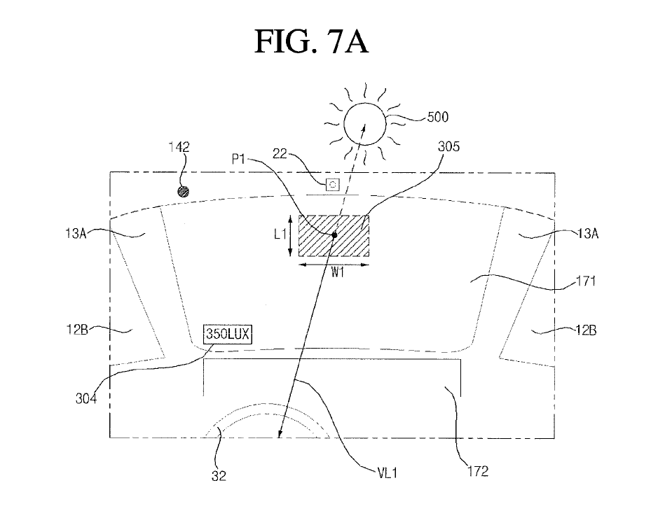

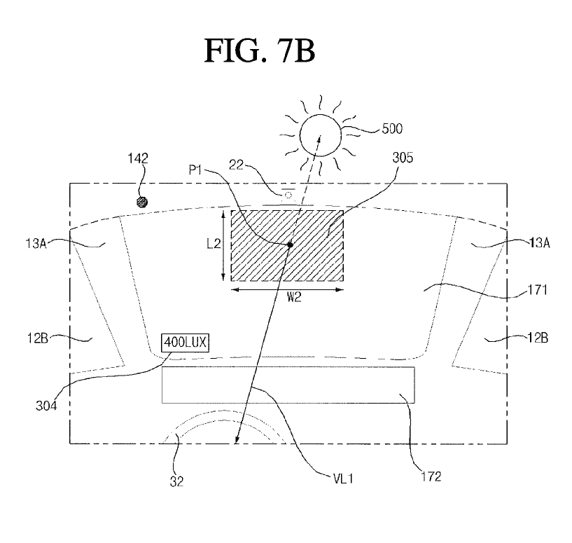

FIGS. 7A and 7B are diagrams showing another example in which the display apparatus 100 according to the first embodiment of the present invention controls the display 170. For convenience of description, FIGS. 7A and 7B show the case in which the front window 12A is implemented as the transparent display 171.

The controller 190 may sense the interior illuminance of the vehicle 1 using the illuminance sensor 142. The controller 190 may display information 304 indicating the value of the sensed illuminance on one side of the transparent display 171. In addition, the sensing unit 140 may sense the position of the sun 500 using the sun tracker sensor 143. The sun tracker sensor 143 may be provided on one side of the vehicle (e.g., the roof).

As the interior illuminance of the vehicle 1 is increased, the driver may be blinded. In order to solve such a problem, the controller 190 may generate and display information 305 having a predetermined transmittance value or less on the transparent display 171 when the sensed illuminance is greater than or equal to a pre-stored value. Therefore, since sunlight introduced into the interior of the vehicle 1 is blocked, the blinding of the driver can be reduced.

Referring to FIG. 7A, the controller 190 may display a graphic object 305 having a size corresponding to the interior illuminance value on the transparent display 171 if the interior illuminance sensed by the illuminance sensor 142 is greater than or equal to a predetermined value. For example, as shown, if the interior illuminance is 350 Lux, the controller 190 may control display of the graphic object 305 having the predetermined transmittance value or less with a width W1 and a length L1.

In addition, the controller 190 may control the display position of the graphic object 305 having the predetermined transmittance value or less based on the position of the sun 500 sensed by the sun tracker 143, when the illuminance sensed by the illuminance sensor 142 is greater than or equal to a predetermined value. More specifically, the controller 190 may determine an area including a point P1 where a virtual line VL1 connecting the point of gaze of the driver and the position of the sun 500 and the transparent display 171 intersect as an area in which the information 305 having the predetermined transmittance value or less is displayed.

FIG. 7B shows a state in which the position of the sun 500 is not changed but the illuminance sensed by the illuminance sensor 142 is increased (see reference numeral “304”), as compared to FIG. 7A. Referring to FIG. 7B, the controller 190 may increase the size of the graphic object 305 having the predetermined transmittance value or less as the sensed illuminance is increased. That is, as shown, when the interior illuminance is increased from 350 Lux to 400 Lux, the controller 190 may control display of the graphic object 305 having the predetermined transmittance value or less with a width W2 and a length L2. At this time, W2 is greater than W1 and L2 is greater than L1. For example, increase of the width and length of the graphic object 305 may be proportional to increase of the interior illuminance. In addition, the maximum size of the graphic object 305 may be determined by experimentation so as not to obstruct the field of vision of the driver.

In contrast, the controller 190 may gradually decrease the size of the graphic object 305 having the predetermined transmittance value or less as the interior illuminance is decreased.

The controller 190 may control the total area of a variety of information displayed on the transparent display 171 not to exceed a predetermined ratio to the total area of the transparent display 171 based on the internal environment information. When the size or amount of information displayed on the transparent display 171 is excessively increased, the field of vision of the driver may be obscured or the attention of the driver may be deteriorated.

For example, when n pieces of information are generated according to the internal environment information of the vehicle 1 and a sum of the display areas of the n pieces of information exceeds 20% the total area of the transparent display 171, the controller 190 may decrease the size of the n pieces of information.

As another example, when n pieces of information is generated according to the internal environment information of the vehicle 1 and a sum of the display areas of the n pieces of information exceeds 20% the total area of the transparent display 171, the controller 190 may display only a predetermined amount of information of the n pieces of information on the transparent display 171 in descending order of priority. For example, the priority of the information indicating the speed of the vehicle 1 may be set to be higher than that of the information indicating information about a music file which is currently being played back. The priority of the information may be set or changed according to driver input.

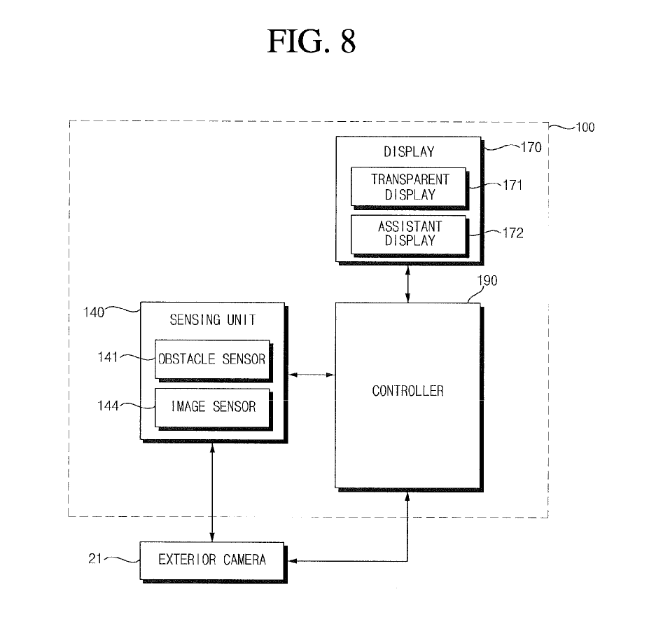

FIG. 8 is a diagram showing the function of a display apparatus 100 according to a second embodiment of the present invention.

Referring to FIG. 8, the display apparatus 100 according to the second embodiment of the present invention may include a display 170, a sensing unit 140 and a controller 190. At this time, the display 170 may include at least one transparent display 171. In addition, the display 170 may include at least one assistant display 172. In addition, the display apparatus 100 may further include a communication unit 120.

The transparent display 171 is equal to that of the first embodiment described with reference to FIG. 3 and a detailed description thereof will thus be omitted.

The sensing unit 140 may acquire external environment information of the vehicle 1. The sensing unit 140 may include at least one sensor for sensing the external state of the vehicle 1. Here, the external environment information of the vehicle 1 means information about the external environment of the vehicle 1. For example, the external surrounding environment information may include driving image information, accident information, obstacle information, etc.

More specifically, the driving image information may include a front image, a left image, a right image or a rear image of the vehicle 1. In addition, the driving image information may include an image of a blind spot which cannot be viewed by the driver seated on the driver seat. The sensing unit 140 may generate driving image information using at least one exterior camera 21 provided on the exterior of the vehicle 1.

In addition, the obstacle information may include information about presence/absence of an obstacle located within a predetermined distance from the vehicle 1. In addition, the obstacle information may include information about the distance from the vehicle 1 to the obstacle, the number of obstacles, the position of the obstacle, the speed of the obstacle, etc. The sensing unit 140 may generate obstacle information using the at least one obstacle sensor 141 provided on the exterior of the vehicle 1. The obstacle sensor 141 may include a laser sensor, an ultrasonic sensor, an infrared sensor, etc. The obstacle sensed by the obstacle sensor 141 may include a moving object such as another vehicle or a pedestrian and a fixed object such as a building.

The communication unit 120 receives a variety of information about the external surrounding environment of the vehicle 1 via wired or wireless communication with an external device. The communication unit 120 may receive external environment information from the external device. The external device may be a mobile terminal of a driver or a passenger or an external server. The external environment information received by the communication unit 120 from the external device may include a variety of information such as position information, route information, weather information, accident information, etc.

For example, the communication unit 120 may receive a global positioning system (GPS) signal from the external device and calculate the current position of the vehicle 1 based on the received GPS signal.

In addition, the communication unit 120 may transmit a request for calculating a route including current position and destination information to the external device and receive route information of at least route from the current position to the destination.

In addition, the communication unit 120 may receive weather information of the current position from the external device. The weather information may include a variety of information related to weather, such as temperature, humidity, wind speed, snow, rain, fog, hail, etc.

The communication unit 120 may receive accident information from the external device. At this time, the accident information may include only information about accidents occurring on the route according to the route information. The accident information may include a distance from the current position of the vehicle 1 to an accident point, an accident type, a cause of accident, etc.

The controller 190 may control operations of the display 170, the sensing unit 140 and the communication unit 120. For example, the controller 190 may generate predetermined information based on information received from the sensing unit 140 or the communication unit 120 and display the generated information on the transparent display 171. The controller 190 may analyze data received from the communication unit 120, the sensing unit 140 or the exterior camera 21 and acquire external environment information.

More specifically, the controller 190 may display information corresponding to the driving image received from the exterior camera 21 on the transparent display 171. The exterior camera 21 may be mounted near the bonnet, side-view mirrors, pillar or license plate of the vehicle 1. The position, number, type, etc. of the interior camera 21 mounted on the vehicle 1 may be diverse.

The controller 190 may change the display position of the display 170 according to the type of the driving image. For example, the controller 190 may display a rear image on the center upper area of the transparent display 171, display a left image on the left upper area of the transparent display 171 and display a right image on the right upper area of the transparent display 171.

In addition, the controller 190 may change predetermined information displayed on the display 170 based on the obstacle information received from the sensing unit 140. For example, when an obstacle approaches the vehicle at the left rear side of the vehicle 1, the controller 190 may enlarge the left image displayed on the transparent display 171 in correspondence with the distance from the obstacle. For example, when an obstacle approaches the vehicle at the right rear side of the vehicle 1, the right image displayed on the transparent display 171 may be periodically switched on and off.

In addition, the controller 190 may display information corresponding to the route information received via the communication unit 120 on the transparent display 171. For example, the controller 190 displays information indicating a left arrow on the transparent display 171, when information about a sharp curve to the left within a predetermined distance from the current position of the vehicle 1 is included in the route information.

Thereafter, when the vehicle 1 passes the sharp curve, the controller 190 may remove the left arrow from the transparent display 171.

In addition, the controller 190 may display information corresponding to the weather information received via the communication unit 120 on the transparent display 171. For example, the controller 190 may compare the weather information with a pre-stored weather condition (e.g., bad weather) and display information (e.g., a virtual lane) indicating a current driving route on the transparent display 171 if the weather information is equal to the pre-stored weather in the result of comparison.

In addition, the controller 190 may display information corresponding to a blind spot image received from the exterior camera 21 on the display 170. For example, one assistant displays 172 may be provided to the interior surface of each front pillar 13A of the vehicle 1 and one exterior cameras 21 may be provided to the exterior surface of each front pillar 13A. In this case, the controller 190 may display the blind spot image received from the exterior camera 21 provided on the exterior surface of the front pillar 13A on the assistant display 172 provided to the interior surface of the front pillar 13A.

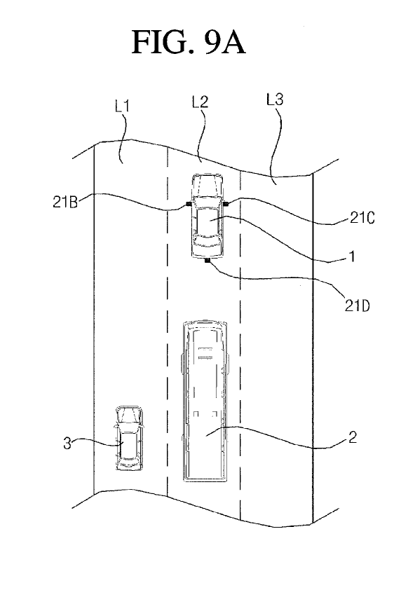

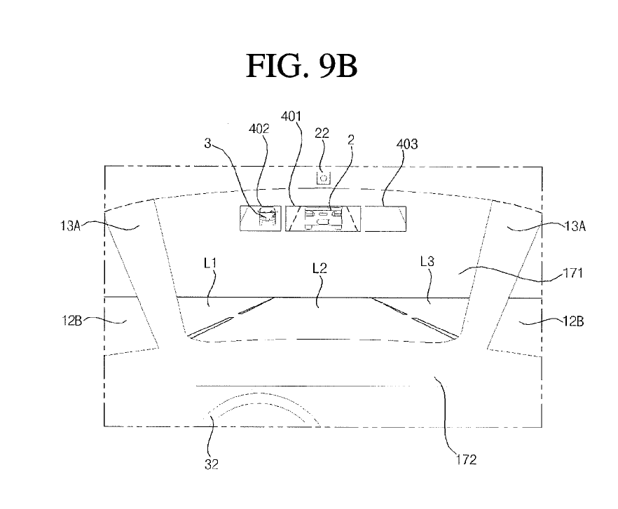

FIGS. 9A and 9B are diagrams showing an example in which the display apparatus 100 according to the second embodiment of the present invention controls the display 170. FIGS. 9A and 9B show the case in which the front window 12A is implemented as the transparent display 171.

The controller 190 may generate a driving image using the exterior camera 21 provided in the vehicle 1. Several exterior cameras 21 may be provided at various positions of the exterior of the vehicle 1 to capture the periphery of the vehicle 1. On the driving image, various objects such as other vehicles located near the vehicle 1 and ground state such as lane may be displayed.

FIG. 9A shows a state in which the vehicle 1 is driving on a three-lane road. Assume that no vehicle is driving in front of the vehicle 1. Referring to FIG. 9A, the vehicle 1 is driving in a second lane L2 of the three-lane road. In addition, a bus 2 is driving in the second lane L2 behind the vehicle 1 and a compact car 3 is driving in a first lane L1 at the left rear side of the vehicle 1. In addition, no vehicle is driving in the third lane L3.

FIG. 9B shows an example in which a left image 402, a right image 403 and a rear image 401 are displayed on the transparent display 171 in the state shown in FIG. 9A. The controller 190 may display the left image 402 at the left side of the rear image 401 and display the right image 403 at the right side of the rear image 401. Referring to FIG. 9A, the left image 402 may be generated by the second exterior camera 21B, the right image 403 may be generated by the third exterior camera 21C and the rear image 401 may be generated by the fourth exterior camera 21D.

In this case, the bus 2 which is driving in the second lane L2 may appear on the rear image 401, the compact car 3 which is driving in the first lane L1 may appear on the left image 402 and only the ground of the third lane L3 in which no vehicle is driving may appear on the right image 403.

Since the driver may check the circumstance of the vehicle 1 via the driving image displayed on the transparent display 171, even when the driver wishes to change the lanes or pass another vehicle, the driver need not change the gaze in order to check the distance from another vehicle.

The rear image 401 may replace the function of a rear-view mirror. In addition, the left image 402 and the right image 403 may supplement or replace the function of side-view mirrors (see reference numerals 14A and 14B of FIG. 1A) mounted at both sides of the vehicle 1.

The driving image may include not only the left image 402, the right image 403 and the rear image 401 but also a front image generated by the first exterior camera 21A and a blind spot image generated by fifth and sixth exterior cameras 21F.

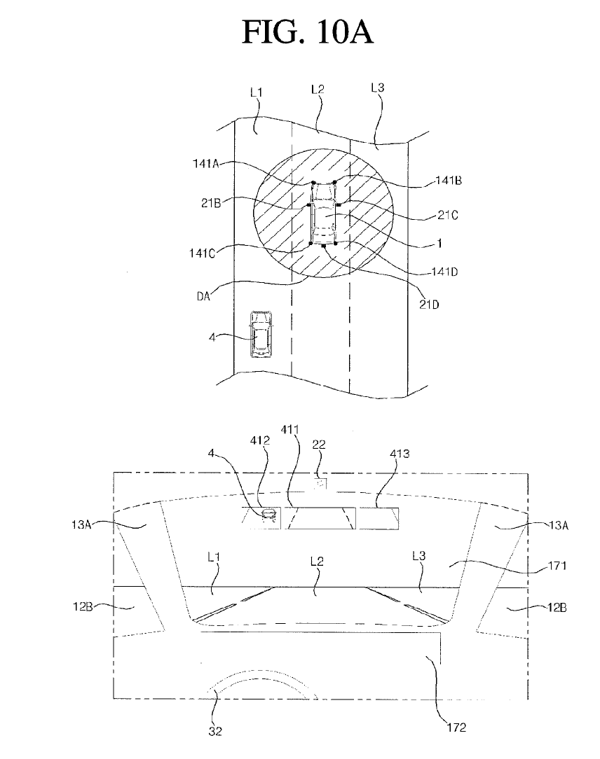

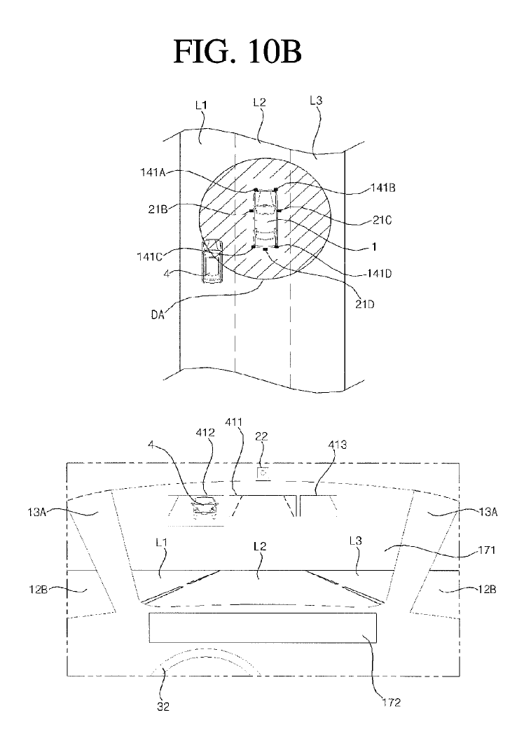

FIGS. 10A and 10B are diagrams showing another example in which the display apparatus 100 according to the second embodiment of the present invention controls the display 170. FIGS. 10A and 10B show the case in which the front window 12A is implemented as the transparent display 171.

The controller 190 may change the size, position, color, transmittance, etc. of the driving image displayed on the transparent display 171 according to the external environment information of the vehicle 1.

FIGS. 10A and 10B shows a state in which the controller 190 controls the size of any one piece of driving image displayed on the transparent display 171 according to obstacle information of the external environment information, for convenience of description. The obstacle sensor 141 may sense an obstacle located within a detection area (hereinafter, referred to as a DA) of the vehicle 1 and the controller 190 may control the size of the driving image based on the sensed obstacle information. The detection area DA may have a circular shape centered on the center of gravity of the vehicle 1.

Several obstacle sensors 141 may be mounted at various positions of the exterior of the vehicle 1. For convenience of description, FIGS. 10A and 10B illustrate a state in which four obstacle sensors 141A to 141D are mounted.

Referring to FIG. 10A, the left image 412, the rear image 411 and the rear image 413 may be displayed on the transparent display 171 in parallel as the driving images. As shown, since no obstacle is located in the detection area DA, the controller 190 does not change the size of the driving image.

Referring to FIG. 10B, as another vehicle 4 moves into the detection area DA, at least one of the four obstacle sensors 141A to 141D may sense the vehicle 4 as an obstacle. Since the vehicle 4 appears on the left image 412 generated by the second exterior camera 21B, the controller 190 may increase only the size of the left image of the driving images which are being displayed on the transparent display 171. The controller 190 may increase the size of the left image 412 within a predetermined area as the vehicle 4 approaches the vehicle 1. Of course, when the vehicle 4 moves away from the vehicle 1 to escape from the detection area, the controller 190 may return the increased size of the left image 412 to the original size of the left image.

Although FIG. 10B shows the state of controlling the size of the driving image, this is only exemplary and the other visual effects may be generated. For example, when an obstacle is located in the detection area DA, the controller 190 may change the color of at least some border of the driving images which are being displayed on the transparent display 171 to red and control light to flicker on and off.

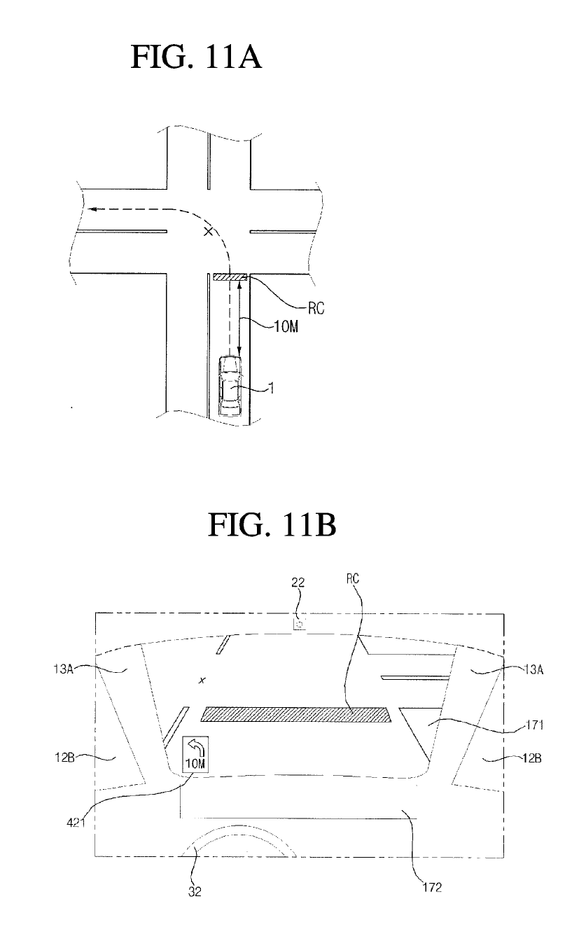

FIGS. 11A and 11B are diagrams showing another example in which the display apparatus 100 according to the second embodiment of the present invention controls the display 170. For convenience of description, FIGS. 11A and 11B show the case in which the front window 12A is implemented as the transparent display 171.

The controller 190 may display information 421 corresponding to route information received via the communication unit 120 on the transparent display 171. The information corresponding to the route information may be changed according to the current position of the vehicle 1. For example, when the vehicle 1 passes a first position on the route, the information displayed on the transparent display 171 may be different from information displayed at a second position on the route.

Referring to FIG. 11A, the controller 190 may determine a course change point RC closest to the current position of the vehicle 1 based on the route information. As shown, when a left-hand turn section is present on a current driving route, the course change point RC may correspond to a point just before the vehicle 1 enters an intersection, as shown.

FIG. 11B shows an example of the information 421 displayed on the transparent display 171 in the state of FIG. 11A. For convenience of description, assume that the information 421 includes an arrow image indicating a scheduled travel direction and a text indicating a distance to the course change point RC.

The controller 190 may display the information 421 indicating the left-hand turn section on the transparent display 171 when the current position of the vehicle 1 is within a predetermined distance from the course change point RC on the route according to the route information. The information 421 may include an arrow image indicating a scheduled travel direction.

In this case, the display position of the information 421 may be changed according to the driving direction of the vehicle 1 to be changed at the course change point RC. For example, at the course change point RC connected to the left-hand turn section, as shown, the controller 190 may display the information 421 at the left side of the transparent display 171. In contrast, at the course change point RC connected to the right-hand turn section, the information 421 may be displayed at the right side of the transparent display 171.

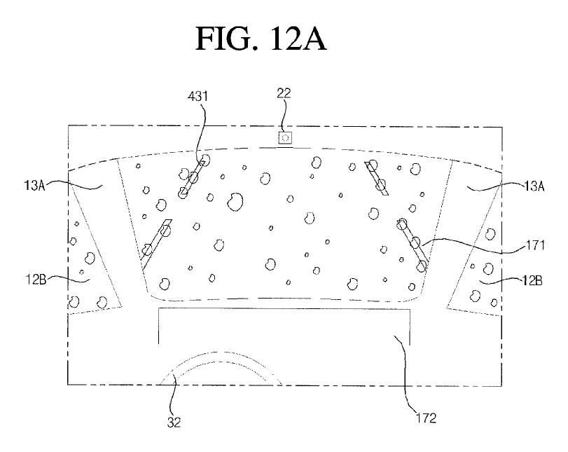

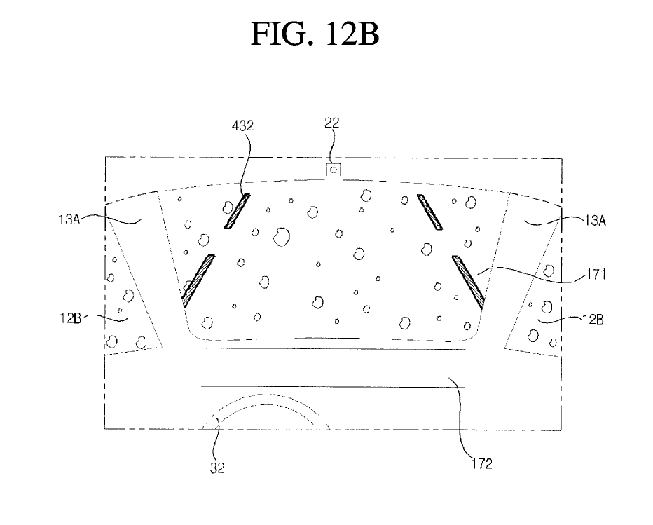

FIGS. 12A and 12B are diagrams showing another example in which the display apparatus 100 according to the second embodiment of the present invention controls the display 170. For convenience of description, FIGS. 12A and 12B show the case in which the front window 12A is implemented as the transparent display 171.

The controller 190 may display the weather information received via the communication unit 120 on the transparent display 171. The weather information may be changed according to the type of weather. The controller 190 may compare the weather information with a pre-stored weather condition and display a graphic object indicating a current driving route on the transparent display 171 when it is determined that the current weather corresponds to bad weather.

In FIGS. 12A and 12B, for convenience of description, assume that the current weather determined based on the weather information is heavy rain corresponding to bad weather.

First, referring to FIG. 12A, as raindrops run down the outside of the transparent display 171, an actual lane 431 drawn on the ground of the driving route may not be visible to the driver.

FIG. 12B shows an example of a virtual lane 432 displayed on the transparent display 171 in the state shown in FIG. 12A. The controller 190 may display the virtual lane 432 on the transparent display 171 as information indicating the current driving route. The controller 190 may display the virtual lane 432 at a position corresponding to the actual lane 431 in the entire area of the transparent display 171. As a result, the driver may check the virtual lane 432 overlapping the actual lane 431.

More specifically, the route information received via the communication unit 120 may include the number of lanes on which the vehicle 1 is currently driving, a curve direction, a road width, etc. Accordingly, the controller 190 may determine and display the direction, form, length, width, etc. of the virtual lane 432 corresponding to the current position of the vehicle 1 on the transparent display 171 based on the route information.

Referring to FIGS. 12A and 12B, when a possibility that an obstacle occurs in the field of vision of the driver due to heavy rain is high, the information 432 indicating the driving route of the vehicle 1, such as a virtual lane, may be displayed to aid to improve driver safety.

The controller 190 may analyze the route information and determine whether the vehicle 1 is currently in a no-passing zone.

When the vehicle 1 is in a passing zone, the controller 190 may display the information 432 as a dotted line as shown in FIG. 12B. When the vehicle 1 enters a no-passing zone, the controller 190 may change the virtual lane displayed in the form of the dotted line to the virtual lane displayed in the form of a solid line.

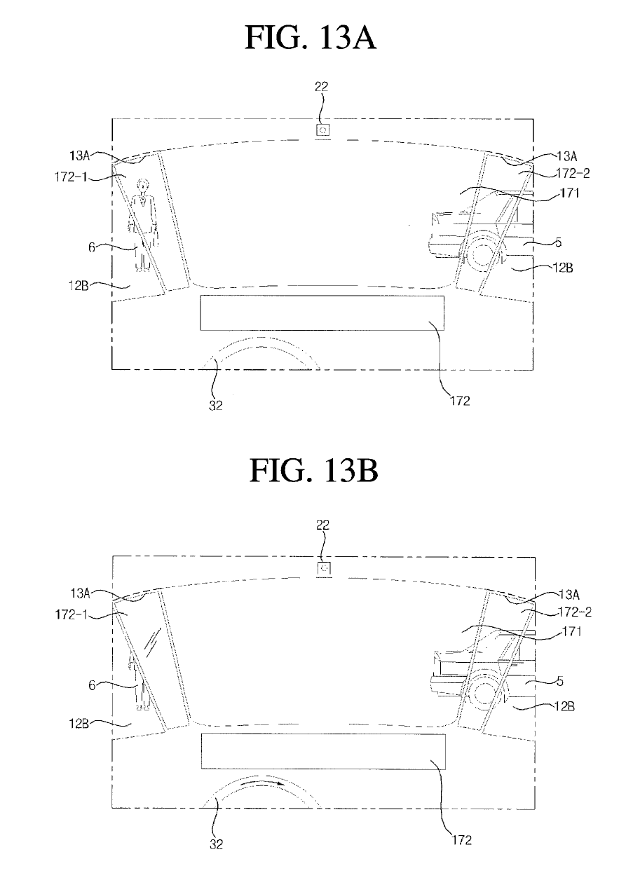

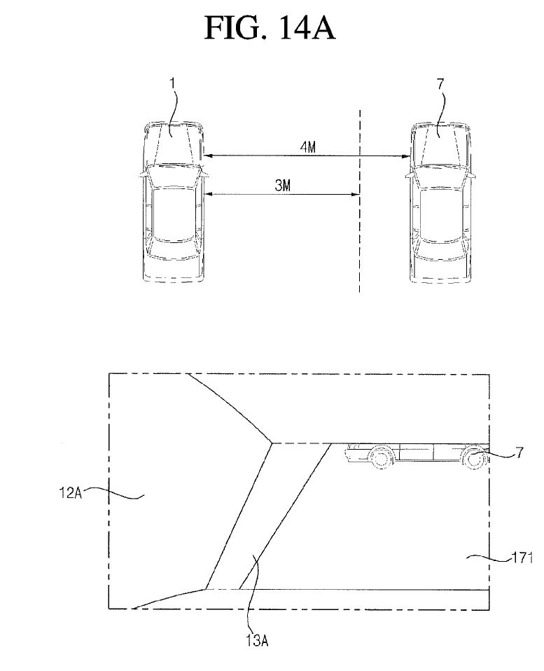

FIGS. 13A and 13B are diagrams showing another example in which the display apparatus 100 according to the second embodiment of the present invention controls the display 170. For convenience of description, FIGS. 13A and 13B show the case in which the front window 12A is implemented as the transparent display 171.

The controller 190 may generate a blind spot image using the exterior camera 21. In the present invention, the blind spot means an area which is not visible to the driver due to obstruction of the field of vision of the driver by a specific part of the vehicle 1.

In FIGS. 13A and 13B, an area in the field of vision of the driver obscured by a pair of front pillars 13A may correspond to a blind spot. For convenience of description, assume that the fifth exterior camera 21E and the sixth camera 21F shown in FIGS. 1A and 1B generate a blind spot image corresponding to the area obscured by the pair of front pillars 13A. In addition, assume that the assistant display 172 is mounted on the interior surface of each front pillar 13A to display the blind spot image generated by the fifth exterior camera 21E and the sixth exterior camera 21F. That is, the blind spot image generated by the fifth exterior camera 21E may be displayed on the assistant display 172-1 mounted on the left front pillar 13A and the blind spot image generated by the sixth exterior camera 21F may be displayed on the assistant display 172-2 mounted on the right front pillar 13A.

Referring to FIG. 13A, a blind spot image, in which a pedestrian 6 obscured by the left front pillar 13A appears, is displayed on the left assistant display 172-1. In addition, a blind spot image on which some of another vehicle 5 obscured by the right front pillar 13A appears is displayed on the right assistant display 172-2. As a result, since the field of vision of the driver may widen as if the front pillar 13A is not present, it is possible to cope with an unexpected situation which may occur during driving.

The controller 190 may individually activate the fifth exterior camera 21E and the sixth exterior camera 21F according to the driving direction of the vehicle 1. FIG. 13B shows an example of displaying a blind spot image according to the rotation direction of the steering wheel 32 of the vehicle 1.

Referring to FIG. 13B, as the driver rotates the steering wheel 32 of the vehicle 1 clockwise for right turn, the controller 190 may display the blind spot image generated by the sixth exterior camera 21F on the right assistant display 172-2 mounted on the right front pillar 13A. Thus, the vehicle 5 may be continuously displayed on the transparent display 171, the right assistant display 172-2 and the right side window 12B. In this case, the controller 190 may turn the fifth exterior camera 21E or the assistant display 172-1 mounted on the left front pillar 13A off. Unlike FIG. 13A, since the pedestrian 6 does not appear on the assistant display 172-1, the upper half of the pedestrian 6 is obscured by the left front pillar 13A.

That is, since collision with an obstacle is changed according to the driving direction of the vehicle 1, the controller 190 may selectively display only some of the blind spot image according to the driving direction of the vehicle 1. Therefore, it is possible to reduce power required to display the blind spot image.

The controller 190 may select a blind spot image to be displayed on the assistant display 172 based on information other than the rotation direction of the steering wheel 32. For example, when a left turn light provided in the vehicle 1 is turned on, the controller 190 may activate the fifth exterior camera 21E to display the blind spot image on the left assistant display 172-1. As another example, when it is determined that the vehicle 1 will enter a right turn section based on the route information, the sixth exterior camera 21F may be activated to display the blind spot image only on the right assistant display 172-2. As another example, when the driver detected from the interior image gazes at the left side, the controller 190 may activate the fifth exterior camera 21E.

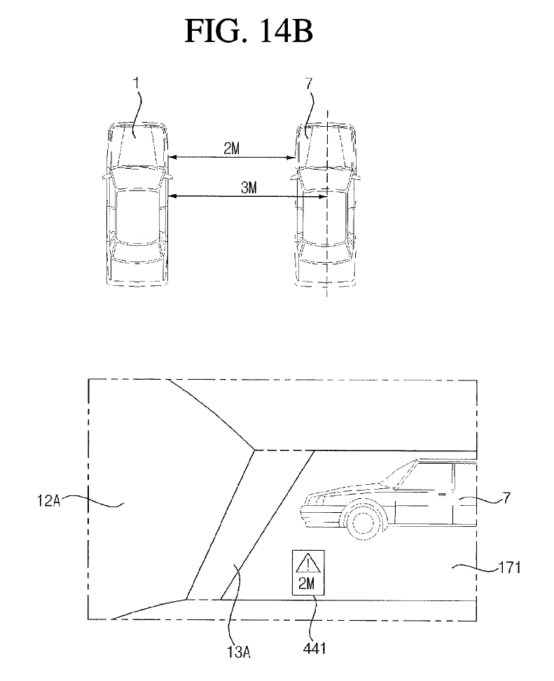

FIGS. 14A and 14B are diagrams showing another example in which the display apparatus 200 according to the second embodiment of the present invention controls the display 170.

The side window 12B as well as the front window 12A may be implemented as the transparent display 171, as described above.

Applying the transparent display 171 to the side window 12B may mean a method of placing the transparent display 171 on the side window 12B or a method of mounting the transparent display 171 instead of the side window 12B. When the transparent display 171 is applied to the side window 12B, the driver can view the outside views of the left and right sides of the vehicle 1. In addition, the driver can confirm a variety of information on the transparent display 171 under control of the controller 190, while viewing the outside views of the left and right sides of the vehicle. For convenience of description, FIGS. 14A and 14B show the case in which the right side window 12B is implemented as the transparent display 171.

FIG. 14A shows the case in which another vehicle 7 is driving at the right side of the vehicle 1 which is currently driving. The sensing unit 140 may sense the distance to the vehicle 7 using the obstacle sensor 141. Information about a risk-of-collision distance may be pre-stored in the memory 130. Assume that the risk-of-collision distance is 3 m. The controller 190 may compare the distance to the vehicle 7 with the risk-of-collision distance and may not display information 441 indicating risk of collision with the vehicle 7 when the distance to the vehicle 7 is greater than the risk-of-collision distance. In the state of FIG. 14A, since the distance to the vehicle 7 is 4 m, which is greater than the risk-of-collision distance of 3 m, the controller 190 may not generate the information 441 indicating risk of collision with another vehicle.

Referring to FIG. 14B, a distance between the vehicle 1 and the vehicle 7 in the state shown in FIG. 14A is reduced such that the vehicle 7 is located within the risk-of-collision distance of 3 m. In this case, the controller 190 may display the information 441 indicating risk of collision with another vehicle sensed via the obstacle sensor 141 on the transparent display 171 applied to the side window 12B. For example, as shown, the information 441 may be expressed by an alert symbol and a numeral indicating the distance to another vehicle.

Although not shown, the left image or the right image corresponding to the image reflected in the side mirrors 14A and 14B may be displayed on the transparent display 171 applied to the side window 12B. As described above, the left image may be generated by the second exterior camera 21B and the right image may be generated by the third exterior camera 21C. When the left image and the right image are displayed on the transparent display 171, the side-view mirrors 14A and 14B mounted outside the vehicle 1 may be obscured by the left image and the right image. Therefore, the driver receives only the left image and the right image to reduce confusion.

The controller 190 may control the total area of a variety of information displayed on the transparent display 171 not to exceed a predetermined ratio to the total area of the transparent display 171 based on the external environment information. When the size or amount of information displayed on the transparent display 171 is excessively increased, the field of vision of the driver may be obscured or the attention of the driver may be deteriorated.

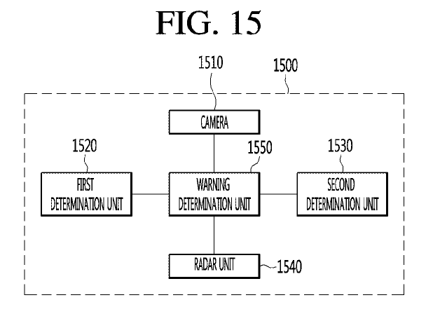

FIG. 15 is a configuration diagram of a driver sensing device according to an embodiment of the present invention.

The driver sensing device 1500 according to the embodiment of the present invention includes a camera 1510, a first determination unit 1520, a second determination unit 1530, a radar unit 1540, and a warning determination unit 1550. First, the camera 1510 photographs a driver and transmits image data to the first determination unit 1520. The first determination unit 1520 determines a driver's condition at a plurality of levels by using the received image data, and transmits the determination result to the warning determination unit 1550. In addition, the radar unit 1540 extracts a driver's response characteristics and transmits the extracted response characteristics to the second determination unit 1530. The second determination unit 1530 determines the driver's response characteristics at a plurality of levels and transmits the determination result to the warning determination unit 1550. The warning determination unit 1550 may transmit a variety of information to the user by using the driver's condition and the driver's response characteristics.

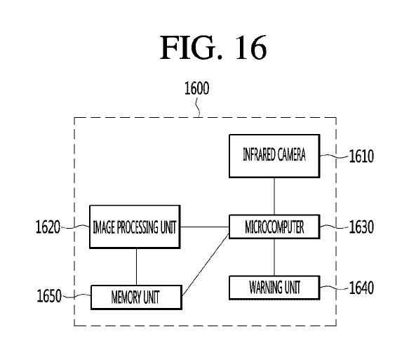

FIG. 16 is a configuration diagram of a driver sensing device according to another embodiment of the present invention.

Referring to FIG. 16, the driver sensing device 1600 includes at least two infrared cameras 1610, an image processing unit 1620, a microcomputer 1630, a warning unit 1640, and a memory unit 1650.

The infrared camera 1610 requires at least two or more infrared cameras so as to acquire a 3D image. The image processing unit 1620 performs 3D modeling on an upper body image including a driver's head, which is captured by the infrared camera 1610. The microcomputer 1630 may determine a driver's gaze direction by using preset reference data and the images taken by two or more infrared cameras 1610 during operation.

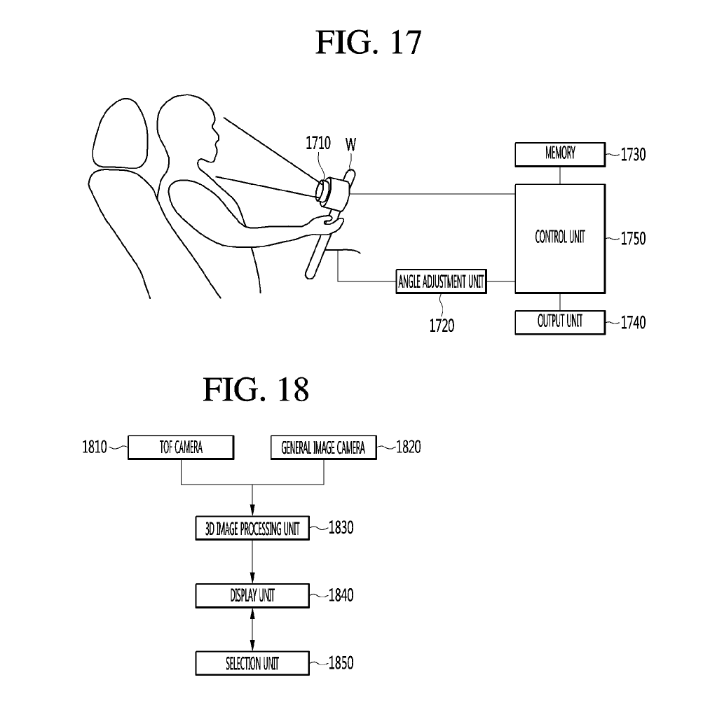

FIG. 17 is a block configuration diagram of a driver condition monitoring device according to an embodiment of the present invention.

As illustrated in FIG. 17, the driver condition monitoring device includes a camera 1710, an angle adjustment unit 1720, a memory 1730, an output unit 1740, and a control unit 1750.

The camera 1710 is mounted on a steering wheel W in a vehicle to acquire an image of a driver. For example, the camera 1710 may be installed on a steering wheel column cover.

The camera 1710 may be implemented by at least one selected from a charge coupled device (CCD) image sensor, a metal oxide semi-conductor (MOS) image sensor, a charge priming device (CPD) image sensor, and a charge injection device image sensor.

The angle adjustment unit 1720 adjusts the angle of the steering wheel W so as to correct the position (photographing range, angle of view) of the camera 1710. In the present embodiment, the case where the position of the camera 1710 is corrected by adjusting the angle of the steering wheel W has been described, but the present invention is not limited thereto. The position of the camera 1710 may be corrected by directly adjusting the angle of the camera 1710.

In other words, the angle adjustment unit 1720 adjusts a tilting angle of the steering wheel W or the camera 1710 to correct the photographing range of the camera 1710.

The memory 1730 stores various data such as a learning model and sample data used for the learning model.

The output unit 1740 outputs a progress status and a result of the operation of the driver condition monitoring device as audiovisual information. This output 1740 includes a display device and/or an audio output device (for example, a speaker). For example, the output unit 1740 outputs information indicating that the tilting angle of the camera 1710 is required be adjusted, a warning sound indicating the automatic adjustment of the tilting angle of the camera 1710, and the like.

The display device (not shown) may include at least one selected from a liquid crystal display (LCD), a thin film transistor-liquid crystal display (TFT LCD), an organic light-emitting diode (OLED) a flexible display, a 3D display, a transparent display, a head-up display (HUD), and a touch screen.

The control unit 1750 extracts a face image from the image acquired through the camera 1710, and confirms the driver's condition through the extracted face image.

The controller 1750 checks whether face detection is possible in the driver image. The control unit 1750 extracts a partial face region from the driver image when the face detection is impossible in the driver image. For example, the control unit 1750 extracts the top, bottom, right, and left end points of the face and the head from the image.

The control unit 1750 detects the face by applying a face feature model to the partial face region. Here, a learning model such as an AdaBoost algorithm may be used as the face feature model.

The control unit 1750 calculates the face cutoff amount based on the detected face information. In other words, the control unit 1750 calculates the partial face region as a difference image based on motion information, and calculates the face cutoff amount of the bottom end by comparing the aspect ratio of the calculated partial face region (for example, 24×20 pixels) with the aspect ratio (for example, 24×24 pixels) of the reference image.

The control unit 1750 corrects the position of the camera 1720 based on the face cutoff amount. The control unit 1750 controls the angle adjustment unit 1720 according to the face cutoff amount to adjust the tilting angle of the steering wheel W. Therefore, the driver condition monitoring device enables the face detection from the driver image.

In the present embodiment, the case where the angle adjustment unit 1720 controls the tilting angle of the steering wheel W has been described, but the tilting angle of the camera 1710 may be directly adjusted.

FIG. 18 is a block configuration diagram illustrating a 3D image display device using a TOF principle.

Referring to FIG. 18, a 3D image display device using a TOF principle according to an embodiment includes a TOF camera 1810, a general image camera 1820, a 3D image processing unit 1830, a display unit 1840, and a selection unit 1850.

The TOF camera 1810 measures the distance between a vehicle and an object around the vehicle. Here, TOF (Time of Flight) refers to the time it takes for the camera module to transmit a short light pulse and return to the camera after the light reaches the surface of the object. That is, the TOF may be determined as a difference between a time t1 when the light is emitted from the camera module and a time t2 when the light is reflected by the object and detected, and is defined by Equation 1 below.

TOF=t2−t1 Equation 1

A distance d of the object measured through the TOF camera may be expressed by Equation 2 below.

d=(c×TOF)/2 Equation 2

c is the speed of light.

The general image camera 1820 photographs an object and obtains a 2D RGB image thereof.

The 3D image processing unit 1830 obtains the 2D RGB image from the general image camera 1820 and synthesizes a 3D image by reflecting distance information derived from the TOF camera 1810 to each pixel contrast value of the 2D RGB image. That is, a final RGBD image having a color (RGB) value and a D (depth) value is completed by increasing a contrast value to a certain value higher than an original contrast value of the pixel when the distance is close and reducing a contrast value to a certain value lower than an original contrast value of the pixel when the distance is far.

The 3D image synthesis will be described in more detail. When the distance of pixel 1 from the vehicle is c, the distance of pixel 2 is d, and the value of d is larger than the value c, based on the TOF distance information obtained from the TOF camera 1810, that is, when the distance of pixel 1 is closer than the distance of pixel 2, the contrast value a of pixel 1 is increased to a certain value higher than the original value, and the contrast value b of pixel 2 is reduced to a certain value lower than the original value in the 2D RGB image. The contrast value of pixel 1 of the 2D RGBD synthesis image obtained through the above-described processing is e, and the contrast value of pixel 2 is f. The 2D RGBD synthesis image is a 3D image that can estimate the space and the position by expressing the effect that the near object is relatively bright and the far object is relatively dark.

In addition, the 3D image processing unit synthesizes the 3D image by combining the distance information obtained by the TOF camera 1810 in each direction with the image taken from the general image camera 1820 in each direction installed on the front, rear, left, and right sides of the vehicle, and merges the 3D images in each direction. In addition, the merged 3D image is processed so as to be displayed in a vertical angle of view. When the top view image is displayed at a vertical angle of view with respect to the 3D image of the vehicle and the entire 360 degree environment surrounding the vehicle through the above processing, the 3D image that looks like looking down from the sky is provided to the driver.

The display unit 1840 displays the 3D image on the display device positioned in the vehicle.

The selection unit 1850 allows the vehicle driver to select the type of the 3D image. The 3D image may include front, rear, left, and right 3D images, a 3D image obtained by merging 3D images in each direction, and a top view 3D image looking like from the sky at a vertical angle of view. The selection unit may be a touch screen type or a button type.

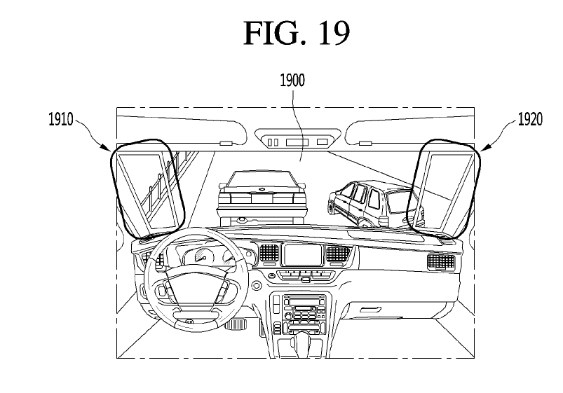

FIGS. 19 to 22 are diagrams for explaining examples in which a display device according to still further embodiment of the present invention controls a display according to a driver's viewing angle.

As illustrated in FIG. 19, the display device according to the embodiment of the present invention may be mounted on a vehicle, and the display device may include a front display unit 1900, a left display unit 1910, and a right display unit 1920. The front display unit 1900 may be mounted in place of the windshield in the windshield of the vehicle. The left display unit 1910 and the right display unit 1920 may be mounted on both sides of the front display unit 1900. Further, the left display unit 1910 and the right display unit 1920 may be mounted at the A-pillar position of the vehicle.

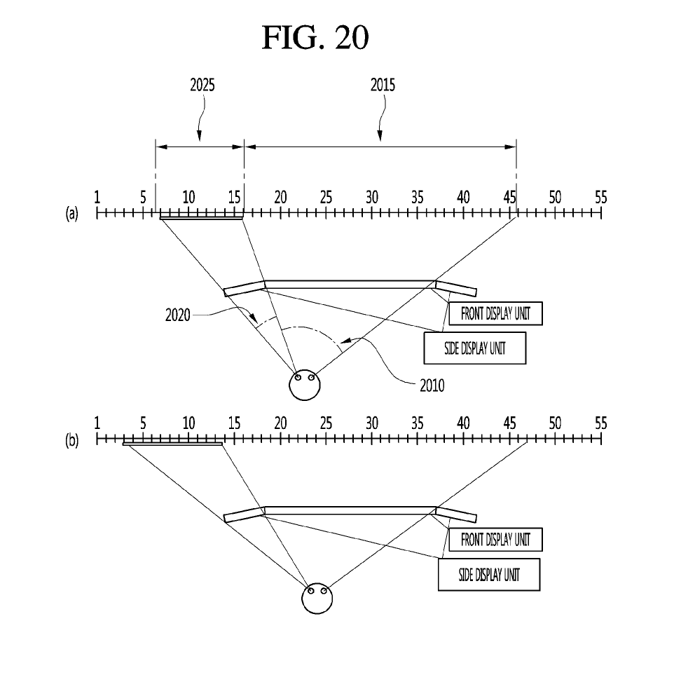

As illustrated in FIG. 20, the display device according to the embodiment of the present invention may include a front display unit and a side display unit (a left display unit and a right display unit). First, a 3D camera may be installed around a cluster in the vehicle, and the control unit may measure the viewing angle of the user based on sensing data of the 3D camera. The viewing angle of the user may include a first viewing angle 2010 corresponding to a first visible view 2015 which can be viewed through the front display unit, and a second viewing angle 2020 corresponding to a second visible view 2025 which can be viewed through the side display unit,

As described above, the display device according to the embodiment of the present invention may measure a visible view through the position of the user's eyes, the distance between the user's eyes and the front display unit and the side display unit through the 3D camera installed inside the vehicle. Therefore, the control unit of the display device may determine the final viewing angle through the data measured through the 3D camera. The screen corresponding to the measured first visible view 2015 may be displayed on the front display unit, and the left and right screens corresponding to the second visible view 2025 may be displayed on both sides of the side display unit. Further, the front display unit may be a windshield of a general vehicle.

In addition, an external camera may be installed outside the vehicle, and the external camera may capture an image corresponding to the second visible view 2025. When the second visible view 2025 is determined, the display device according to the embodiment of the present invention may process the image data input through the external camera and display the left side image and the right side image on the side display unit in the form of extending in the left and right directions of the first visible view 2015. Therefore, by designing as illustrated in FIG. 20, the user can be provided with a wider visible view that further extends to the left and right side by a predetermined region than the front view through the conventional front display unit.

In addition, the display device according to the embodiment of the present invention provides the front visible view in the general mode through only the front display as in the conventional case, and provides the side visible view through the side display when the command of the user is input.

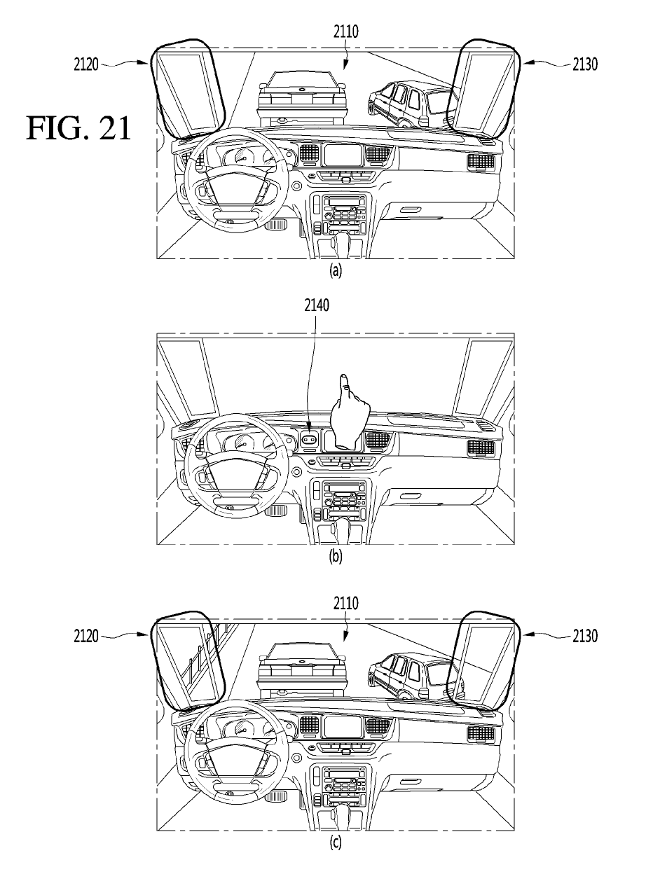

For example, as illustrated in FIG. 21(a), in the normal mode, the display device may provide the front visible view through the front display unit 2110, and the side display units 2120 and 2130 may not provide the visible view. As illustrated in FIG. 21(b), in the normal mode, the 3D camera 2140 installed in the vehicle may sense a predetermined hand gesture input by the user during driving. In this case, the 3D camera may measure the visible view through the position of the user's eyes, the distance between the user's eyes and the front display unit 2110 and the side display units 2120 and 2130 as described with reference to FIG. 20. Therefore, the control unit of the display device may determine the final viewing angle through the data measured through the 3D camera 2140. As illustrated in FIG. 21(c), the screen corresponding to the measured first visible view may be displayed on the front display unit, and the left and right screens corresponding to the second visible view may be displayed on both sides of the side display unit. In addition, the front display unit may be a windshield of a general vehicle, and an image screen may be output only on the side display units 2120 and 2130.

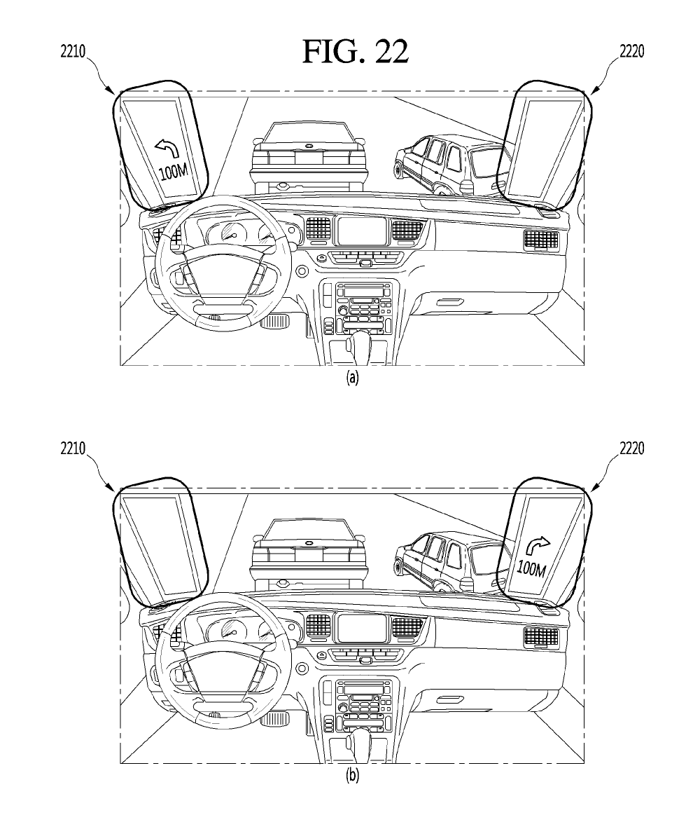

In addition, as illustrated in FIGS. 22(a) and 22(b), the display device according to the embodiment of the present invention may interwork with a navigation of the vehicle. For example, when the navigation of the vehicle carries out a left turn route guidance at a predetermined distance ahead, the information may be transmitted to the display device, and the control unit of the display device may display a left turn route guidance indicator on the left display unit 2210. In addition, when the route guidance is a right turn route guidance, the control unit of the display device may display a right turn route guidance indicator on the right display unit 2220. Therefore, as illustrated in FIG. 22, there is a technical effect that a variety of information can be provided to the user in the vehicle without obstructing the front view through the side display unit mounted in the form of extending on the left and right sides of the windshield.

The display device and the control method thereof according to the present invention are not limited to the configuration and method of the embodiments described above, and the embodiments may be configured so that all or some of the embodiments may be selectively combined so as to make various modifications.

The preferred embodiments of the invention described above are disclosed for illustrative purposes. It will be apparent to those skilled in the art that various modifications, additions, and substitutions can be made thereto without departing from the scope and spirit of the invention, and such modifications, alterations, and additions should be regarded as falling within the scope of the appended claims.

1. A display device comprising:
a front display unit;
a side display unit comprising a left display unit and a right display unit;
a communication unit configured to receive external image data;
a sensing unit configured to sense a user; and
a control unit configured to control an operation of the display device,
wherein the control unit is configured to:
measure a position of a user's eyes within a vehicle and a distance between the front display unit and the side display unit and the user's eyes by using the sensing unit;
calculate a visible view and a viewing angle of the user through the measured data; and
process the external image data corresponding to the calculated visible view and perform control to output the processed external image data on the side display unit.

2. The display device according to claim 1, wherein the front display unit comprises a windshield of the vehicle.

3. The display device according to claim 1, wherein the side display unit is mounted on an A-pillar position of the vehicle.

4. The display device according to claim 1, wherein the sensing unit comprises a 3D camera, and
the sensing unit is configured to sense the position of the user's eyes and sight direction information through the 3D camera.

5. The display device according to claim 4, wherein the 3D camera is provided in a predetermined region of a steering wheel mounted on a front surface of a driver's seat of the vehicle.

6. The display device according to claim 1, wherein the external image data is image data photographed through a general image camera and a time of flight (TOF) camera installed on the left and right sides of the vehicle.

7. The display device according to claim 6, wherein the general image camera is configured to obtain 2D RGB images of left and right sides of the vehicle, and
the control unit is configured to combine distance information measured by the TOF camera with each pixel of the 2D RGB image.

8. The display device according to claim 1, wherein the display device further comprises a user interface unit, and
the control unit is configured to control the side display unit to output navigation information upon receiving a navigation guidance request through the user interface unit.

9. A control method of a display device, comprising:
measuring a position of a user's eyes within a vehicle and a distance between a front display unit and a side display unit and the user's eyes by using a sensing unit of the display device;
calculating a visible view and a viewing angle of the user through the measured data; and
processing external image data corresponding to the calculated visible view and outputting the processed external image data on the side display unit.

10. The control method according to claim 9, wherein the front display unit comprises a windshield of the vehicle.

11. The control method according to claim 9, wherein the side display unit is mounted on an A-pillar position of the vehicle.

12. The control method according to claim 9, wherein the sensing unit comprises a 3D camera, and
the sensing unit is configured to sense the position of the user's eyes and sight direction information through the 3D camera.

13. The control method according to claim 12, wherein the 3D camera is provided in a predetermined region of a steering wheel mounted on a front surface of a driver's seat of the vehicle.

14. The control method according to claim 9, wherein the external image data is image data photographed through a general image camera and a time of flight (TOF) camera installed on the left and right sides of the vehicle.
